(19) United States
(12) Patent Application Publication
(10) Pub. No.: US 2026/0328379 A1
(43) Pub. Date: Oct. 22, 2026

(54) LED LUMINAIRE

(71) Applicant: SIGNIFY HOLDING B.V., EINDHOVEN (NL)

(72) Inventor: FENG PAN, SHANGHAI (CN)

(21) Appl. No.: 19/104,332

(22) PCT Filed: Aug. 7, 2023
(86) PCT No.: PCT/EP2023/071778

§ 371 Date: Feb. 17, 2025

(30) Foreign Application Priority Data
Aug. 15, 2022 (WO) PCT/CN2022/112518
Sep. 27, 2022 (EP) 22197912.3

(51) Int. Cl. F21V 23/00; F21Y 115/10

(52) U.S. Cl. CPC F21V 23/009; F21Y 2115/10

(57) ABSTRACT

An LED luminaire (100), comprising: an LED driver (110) for powering a light emitting arrangement; a support (120) for the LED driver; a mounting arrangement (130) for securing the LED driver to the support; and a covering element (150) configured to movably cover and uncover the LED driver; wherein the mounting arrangement comprises a driver movement system (140) configured to move the LED driver away from the support and towards the covering element responsive to the covering element moving to cover the LED driver.

### FIELD OF THE INVENTION

The invention relates to the field of LED luminaires.

### BACKGROUND OF THE INVENTION

LED drivers are used in LED luminaires to regulate the power provided to the LED(s) of the luminaire (e.g. converting AC to DC). The reliability and lifetime of an LED driver is affected by its temperature, and overheating is a common cause of failure of LED drivers. It is therefore important that the temperature of an LED driver is controlled not to exceed a desired value.

Further, many LED luminaires are fitted with replaceable LED drivers in order to maintain performance of the luminaire. Generally, a replaceable LED driver is installed in a cavity within the housing, and is replaced by opening a back cover in the housing.

Replacement of an LED driver can be difficult when the luminaire is installed in a high or otherwise difficult-to-access position, such as in street lamps, spotlights on the edges of billboards and floodlights in stadiums. It is therefore desirable to fix the driver within the luminaire in a way that allows easy replacement.

There is therefore a need for an improved fixing structure for securing LED drivers in luminaires in a way that reduces a likelihood of overheating and allows easy replacement of the LED driver.

### SUMMARY OF THE INVENTION

The invention is defined by the claims.

According to examples in accordance with an aspect of the invention, there is provided an LED luminaire, comprising: an LED driver for powering a light emitting arrangement; a support for the LED driver; a mounting arrangement for securing the LED driver to the support; and a covering element configured to movably cover and uncover the LED driver; wherein the mounting arrangement comprises a driver movement system configured to move the LED driver away from the support and towards the covering element responsive to the covering element moving to cover the LED driver.

Tolerances in the design of an LED luminaire mean that there is generally a gap between the LED driver and the covering element. Moving the LED driver towards the covering element in response to the covering element closing allows the LED driver to be brought into contact with the covering element of the luminaire, allowing heat from the driver to dissipate through the covering element.

In some examples, the covering element is configured to physically contact or engage with the driver movement system when covering the LED driver; and the driver movement system is configured to move the LED driver away from the support and towards the covering element responsive to the covering element physically contacting or engaging with the driver movement system.

In some examples, the driver movement system comprises a lever configured to move the LED driver away from the support responsive to an application of a pressure at a lever position; and the covering element comprises a lever engagement element configured to engage with and apply pressure to the lever position as the covering element moves to cover the LED driver.

In other words, closing the covering element results in a force being applied to the lever, turning the lever and resulting in the LED driver being pushed towards the covering element.

In some examples, the lever pivots about a fulcrum extending from the support. The fulcrum may extend from a surface of the support on an opposing side of the lever to the covering element in a covering position.

In some examples, the covering element comprises a covering portion configured to cover the LED driver when the covering element is moved to cover the LED driver; and the lever engagement element comprises at least one first elongated member extending from the covering portion.

The at least one first elongated member exerts the force on the lever that turns the lever and causes the LED driver to be pushed towards the covering element.

In some examples, the driver movement system further comprises at least one second elongated member extending from the lever position of the lever, wherein the at least one second elongated member is configured to engage with the lever engagement element as the covering element moves to cover the LED driver.

In other words, at least one elongated member may alternatively or additionally be provided on the lever. A force is exerted on the at least one second elongated member by the covering element as the covering element closes; the at least one second elongated member transmits this force to the lever, causing the lever to turn and push the LED driver towards the covering element.

In some examples, the driver movement system is configured to press the LED driver against the covering element when the covering element covers the LED driver.

Pressing the LED driver against the covering element, so that the LED driver remains in contact with the covering element, increases heat dissipation through the covering element.

In some examples, the driver movement system is made from an elastic metal. An elastic metal is a metal having a high elasticity. For example, a metal may be considered as having a high elasticity if the metal has a Young's modulus of at least 180 GPa, e.g. at least 190 GPa. Other properties, such as the thickness, size and shape of the driver movement system, also affect the elasticity of the driver movement system.

When the device comprises a lever, the use of an elastic metal allows the device to be formed from a single sheet of metal. The device can then be secured within the housing (e.g. screwed to a fitting in the housing) while also having a lever part that deforms when a force is applied and provides a force that pushes the LED driver towards the cover.

The use of an elastic metal is also beneficial when the mounting arrangement is used as a tool-free fixing mechanism for securing the LED driver within the housing, as described below.

In some examples, the elastic metal is SUS301 (a stainless steel). Other suitable elastic metals include spring steels such as 65Mn, 60Si2Mn and 50CrVA, and other steels with a similar Young's modulus.

In some examples, the mounting arrangement further comprises: a clamping portion biased to a first position in which the clamping portion is configured to secure the LED driver to the support; and a declamping mechanism configured to move the clamping portion to a second position in which the clamping portion permits the LED driver to be moved with respect to the support.

In this way, the mounting arrangement can provide a dual purpose of providing improved heat dissipation and providing a tool-free fixing structure for the LED driver. A tool-free fixing mechanism is particularly beneficial when the LED luminaire is in a difficult-to-access position, where a user replacing the LED driver may not have both hands free to remove the LED driver and secure a replaceable LED driver.

In some examples, the clamping portion and the declamping mechanism are integrally formed. In particular, the clamping portion and declamping mechanism may be formed from a single, bent sheet of elastic metal.

The sheet of elastic metal may be bent such that, in the first position, the sheet of elastic metal extends over a part of the LED driver (or a position in which an LED driver is to be placed), and then bends back away from the LED driver position to provide a lever portion.

The portion of the sheet of elastic metal that extends over the LED driver position in the first position is the clamping portion: the clamping portion secures an LED driver within the housing when the clamping portion is in the first position.

The lever portion is configured to be capable of moving the clamping portion to the second position, in which the clamping portion does not extend over the LED driver position, to allow the LED driver to be replaced.

In some examples, the driver movement system, the clamping portion and the declamping mechanism are integrally formed. In particular, the driver movement system, the clamping portion and declamping mechanism may be formed from a single, bent sheet of elastic metal.

In some examples, the covering element is rotatably attached to the support by a hinge. This allows the cover to be opened and closed without the use of any tools, again improving an ease of replacing the LED driver.

In some examples, the LED luminaire further comprises a locking arrangement configured to secure the covering element, when covering the LED driver, to the support.

In some examples, the support and covering element together define, when the covering element covers the LED driver, a housing that houses the LED driver therein.

These and other aspects of the invention will be apparent from and elucidated with reference to the embodiment(s) described hereinafter.

### BRIEF DESCRIPTION OF THE DRAWINGS

For a better understanding of the invention, and to show more clearly how it may be carried into effect, reference will now be made, by way of example only, to the accompanying drawings, in which:

FIG. 1 illustrates a perspective view of an LED luminaire, according to an embodiment of the invention;

FIG. 2 illustrates a cross-sectional view of a portion of the LED luminaire;

FIG. 3 illustrates a perspective view of a mounting arrangement for the LED luminaire;

FIG. 4 illustrates a top view of the LED luminaire;

FIG. 5 illustrates an exploded view of the LED luminaire; and

FIG. 6 illustrates a second perspective view of the LED luminaire.

### DETAILED DESCRIPTION OF THE EMBODIMENTS

The invention will be described with reference to the Figures. It should be understood that the detailed description and specific examples, while indicating exemplary embodiments of the apparatus, systems and methods, are intended for purposes of illustration only and are not intended to limit the scope of the invention. These and other features, aspects, and advantages of the apparatus, systems and methods of the present invention will become better understood from the following description, appended claims, and accompanying drawings. It should be understood that the Figures are merely schematic and are not drawn to scale. It should also be understood that the same reference numerals are used throughout the Figures to indicate the same or similar parts.

There is proposed an LED luminaire comprising an LED driver, a support for the LED driver, a mounting arrangement, and a covering element. The mounting arrangement fixes the LED driver to the support. The covering element is configured to open and close to uncover and cover the LED driver. A driver movement system is configured to move the LED driver towards the covering element in response to the covering element covering the LED driver.

Embodiments are at least partly based on the realization that bringing the LED driver closer to the covering element, and preferably into contact with the covering element, improves heat dissipation of the LED driver, thus improving a reliability and lifetime of the LED driver.

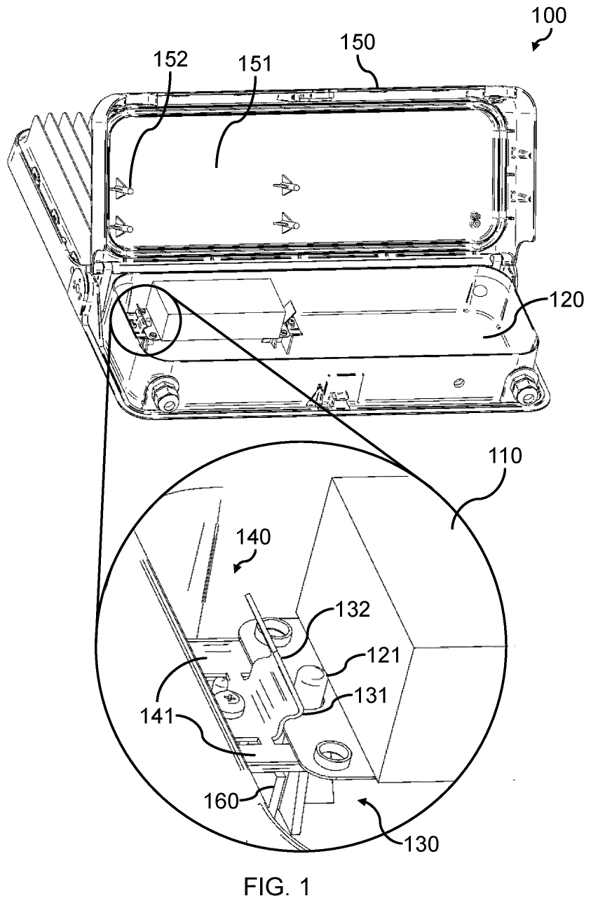

FIG. 1 illustrates a perspective view of an LED luminaire 100, according to an embodiment of the invention. The LED luminaire comprises: an LED driver 110 for powering a light emitting arrangement (not visible in FIG. 1); a support 120 for the LED driver; a mounting arrangement 130 for securing the LED driver to the support; and a covering element 150 configured to movably cover and uncover the LED driver.

In other words, the covering element 150 is movable between an open position, in which the LED driver 110 is uncovered, and a closed position, in which the LED driver is covered. This enables access to the LED driver, e.g. so that the LED driver can be repaired/replaced. In FIG. 1, the covering element 150 is shown in the open position, in order to illustrate the LED driver, the support and the mounting arrangement.

When the covering element 150 of the LED luminaire shown in FIG. 1 is in the closed position (i.e. covering the LED driver 110), the support 120 and covering element together define a housing that houses the LED driver therein.

The light emitting arrangement may be any light emitting arrangement comprising an LED and powered by an LED driver. Suitable light emitting arrangements will be readily apparent to the skilled person. The light emitting arrangement may emit light from a surface of the LED luminaire 100 on an opposite side of the luminaire to the covering element 150, as is the case in FIG. 1 (i.e. the covering element may be provided on the “back” of the luminaire, where the “front” is a light emitting surface).

The LED driver 110 may be any LED driver suitable for the LED luminaire 100. The skilled person will recognize that different types of light emitting arrangement will require different types of LED driver (e.g. having different voltage outputs). Further, the LED driver and the mounting arrangement 130 must fit with respect to one another, in order to secure the LED driver to the support 120 of the LED luminaire.

As the skilled person will readily appreciate, the LED luminaire may further comprise other common components of a luminaire, such as a heat sink and circuitry/wiring. The LED luminaire 100 illustrated in FIG. 1 comprises two mounting arrangements 130, provided at opposing sides of the LED driver 110. However, the skilled person will readily appreciate that this is only one possible configuration, and that the invention is not limited to this configuration. For instance, the LED luminaire may alternatively have a single mounting arrangement (e.g. provided at one side of the LED driver and extending along the length of the LED driver on an opposing side to the covering element in its closed position).

The mounting arrangement 130 secures the LED driver 110 to the support 120. Preferably, the mounting arrangement is also capable of releasing the LED driver from its secured position, allowing the LED driver to be removed from the support 120 for replacement or repair. The use of the mounting arrangement for securing the LED driver to the support will be described in more detail below.

In addition to securing the LED driver to the support 120, the mounting arrangement 130 comprises a driver movement system 140, which is configured to move the LED driver 110 away from the support and towards the covering element 150 responsive to the covering element moving to cover the LED driver.

In other words, the mounting arrangement 130 may secure the LED driver 110 in two positions, according to whether the LED driver is covered or uncovered. The mounting arrangement may secure the LED driver in a first position when the covering element 150 is in an open position, and a second position when the covering element is in a closed position, where the second position is further away from the support 120. The first position (i.e. the position of the uncovered LED driver) may be configured to be closer to the support 120 than the covering element 150 is when in a closed position, to ensure that the covering element is able to fully close.

Preferably, the driver movement system 140 may be configured to press the LED driver 110 against the covering element 150 when the covering element covers the LED driver. In other words, when the LED driver is covered by the covering element, the LED driver is in contact with the covering element. This allows heat produced by the LED driver to dissipate through the covering element via conduction.

In order for the driver movement system 140 to move the LED driver responsive to the covering element 150 moving to cover the LED driver 110, the covering element may be configured to physically contact or engage with the driver movement system when covering the LED driver. In other words, the driver movement system may configured to move the LED driver away from the support 120 and towards the covering element responsive to the covering element physically contacting or engaging with the driver movement system as the covering element moves to cover the LED driver.

In FIG. 1, the driver movement system 140 comprises a lever 141, which pivots about a fulcrum 160 extending from the support 120. The lever is configured to move the LED driver 110 away from the support 120 responsive to an application of a pressure at a lever position. The driver movement system shown in FIG. 1 has two levers, located at opposing ends of the mounting arrangement 130. In alternative driver movement systems, a single lever may be used, for instance, located at a central position of the mounting arrangement.

The application of a pressure at the lever position is responsive to the covering element 150 moving to cover the LED driver 110. For instance, the application of pressure at the lever position may be provided by a lever engagement element of the covering element configured to engage with and apply pressure to the lever position as the covering element moves to cover the LED driver.

In FIG. 1, the covering element 150 comprises a covering portion 151 configured to cover the LED driver 110 when the covering element is moved to cover the LED driver, and the lever engagement element comprises at least one first elongated member 152 extending from the covering portion 151.

The covering portion 151 of the covering element 150 is a surface of the covering element that faces the LED driver 110 when the covering element is in a closed position (i.e. covering the LED driver).

In FIG. 1, the at least one first elongated member 152 extending from the covering portion 151 is a rod, but other elongated members, such as walls, are also envisaged. Four first elongated members extend from the covering portion 151 shown in FIG. 1, each configured to engage with a different lever 141. As will be apparent to the skilled person, the number of first elongated members in an LED luminaire may depend on the number of mounting arrangements, the number of levers each mounting arrangement has, and the number of levers that each first elongated member engages with.

The at least one first elongated member 152 engages with the lever position of the lever 141, causing the lever to pivot about the fulcrum 160 and push the LED driver 110 towards the covering element 150.

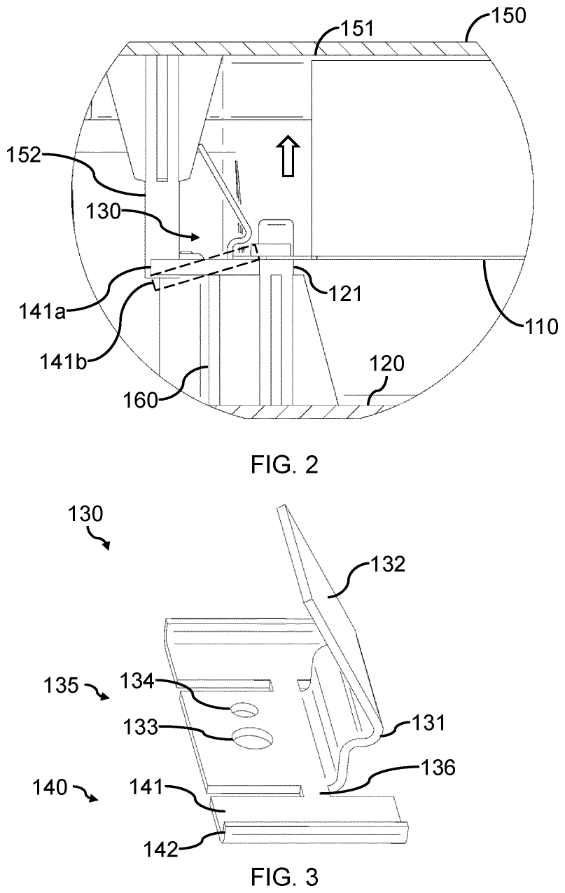

The interactions between the at least one first elongated member 152, the lever 141 and the LED driver 110 may be seen more clearly in FIG. 2, which illustrates a cross-sectional view of a portion of the LED luminaire 100 surrounding the mounting arrangement 130.

FIG. 2 shows the lever 141 in two states. Lever 141a is in a first state, in which no pressure is being applied at the lever position, and the lever is not pushing the LED driver 110 towards the covering element 150. Lever 141a corresponds to a state of the lever when the covering element is in an open position. Lever 141b is in a second state, in which pressure is being applied at the lever position, and the lever is pushing the LED driver towards the covering element. Lever 141b corresponds to a state of the lever when the covering element is in a closed position.

FIG. 2 shows the covering element 150 in a closed position, in which the covering element is covering the LED driver 110. The at least one first elongated member 152 engages with and applies pressure to the lever position of the lever 141, causing the lever to pivot about the fulcrum 160 (i.e. move from the first state 141a to the second state 141b) and push the LED driver towards the covering element 150.

Preferably, the rotation of the lever 141 is sufficient to press the LED driver 110 against the covering element 150, such that the LED driver remains in contact with the covering portion 151 of the covering element while the covering element is in a closed position. Typically, a movement of a few mm (e.g. 2-3 mm) of the LED driver in a direction towards the covering element is required to bring the LED driver into contact with the covering element.

When the covering element 150 moves to uncover the LED driver 110 (i.e. when the covering element opens), the at least one first elongated member 152 moves away from the lever 141, removing the pressure applied at the lever position and causing the lever to pivot about the fulcrum from the second state 141b to the first state 141a. The LED driver may thus be enabled to move towards the support 120 when the LED driver is uncovered.

In some examples, the engagement between the lever position and the lever engagement element may additionally or alternatively be achieved by the use of at least one second elongated member (not shown in FIGS. 1 and 2) extending from the lever position of the lever 141 and configured to engage with the lever engagement element as the covering element 150 moves to cover the LED driver 110. In such examples, the lever engagement element may, for instance, comprise an area of the covering portion 151 that physically contacts or engages with the at least one second elongated member responsive to the covering element 150 moving to cover the LED driver.

As stated above, in addition to comprising the driver movement system 140, the mounting arrangement 130 secures the LED driver 110 to the support 120. Returning to FIG. 1, the mounting arrangement 130 further comprises a clamping portion 131 and a declamping mechanism 132, which together provide a tool-free mechanism for fixing the LED driver 110 to the support and removing the LED driver from the support (e.g. in order to replace the LED driver). A tool-free mechanism is particularly advantageous in LED luminaires installed in difficult-to-access positions, such as street lamps and floodlights.

The clamping portion 131 is biased to a first position in which the clamping portion is configured to secure the LED driver 110 to the support 120. In FIG. 1, the clamping portion is shown in this first position, securing the LED driver to the support.

The clamping portion 131 shown in FIG. 1 is a portion of the mounting arrangement 130 that, in the first position, extends over a part of the LED driver 110 on an opposite side of the LED driver to the support 120, restricting movement of the LED driver in a first direction away from the support.

At least one third elongated member 121 may extend from the support 120 and engage with the LED driver 110 (e.g. with a hole on the LED driver, as in FIG. 1), in order to aid alignment of the LED driver and mounting arrangement when fitting an LED driver to the luminaire, and to restrict movement of the LED driver in a lateral direction (i.e. a direction perpendicular to the first direction). Movement of the LED driver in a lateral direction may also be restricted by friction between the clamping portion 131 and the LED driver.

It should be understood that the restriction of movement of the LED driver 110 by the clamping portion 131 does not prohibit all movement of the LED driver with respect to the support 120. Rather, the clamping portion is configured to allow a sufficient degree of movement of the LED driver in a direction away from the support, such that the driver movement system 140 is able to move the LED driver towards the covering element 150 responsive to the covering element moving to cover the LED driver.

For instance, the clamping portion 131 may be configured to move with the LED driver 110 when the LED driver is moved towards the covering element 150.

Alternatively, a gap may be provided between the clamping portion and the LED driver, with the size of the gap corresponding to an expected distance by which the LED driver is to be moved. The clamping portion may then prevent the LED driver moving beyond the gap.

As the skilled person will readily appreciate, the clamping portion 131 shown in FIG. 1 provides only one mechanism by which the LED driver may be secured to the support 120, such that the LED driver is still capable of a small amount of movement in a direction away from the support. For example, the LED driver may alternatively be secured to the support using screws, e.g. screwing the LED driver to a part of the driver movement system that moves the LED driver, or leaving sufficient space between the head of the screw and the LED driver that the LED driver may slide along a portion of the shank of the screw. A tool-free securing mechanism may be preferred, to improve an ease of replacing the LED driver.

The declamping mechanism 132 is configured to move the clamping portion 131 from the first position to a second position, in which the clamping portion permits the LED driver 110 to be moved with respect to the support 120.

The declamping mechanism 132 shown in FIG. 1 is integrally formed with the clamping portion 131 such that the clamping portion 131 may be moved from the first position to the second position by moving the declamping mechanism. In particular, an application of pressure pushing the declamping mechanism away from the LED driver 110 results in the clamping portion being moved from the first position to the second position, in which movement of the LED driver with respect to the support 120 is permitted. In other words, the declamping mechanism functions as a lever to move the clamping portion.

An LED driver may therefore be removed without the use of tools, using the illustrated declamping mechanism 132, by a user pressing on the declamping mechanism with their hand to move the clamping portion away from the LED driver. A replacement/repaired LED driver may then be fitted to the LED luminaire 100 without the use of tools, by pushing the replacement/repaired LED driver into position. This will cause the LED driver to press on the declamping mechanism, moving the clamping portion into its second position and allowing the LED driver to move past the clamping portion and towards the support 120. Once the LED driver has moved past the clamping portion, the LED driver will no longer be pressing the declamping mechanism, and the clamping portion will return to its biased first position, securing the LED driver to the support.

To further improve an ease of maintenance of the LED luminaire 100, the drive lines (not illustrated in FIG. 1) of the LED driver 110 may be connected by plug-in connectors. This again reduces the need for tools when replacing the LED driver.

FIG. 3 illustrates a perspective view of the mounting arrangement 130, to better illustrate the structure of the mounting arrangement. As shown in FIG. 3, the driver movement system 140, the clamping portion 131 and the declamping mechanism 132 of the mounting arrangement may be integrally formed.

In particular, in the illustrated example, the mounting arrangement 130 is formed from a single sheet that is bent to form the lever 141, the clamping portion 131 and the declamping mechanism 132. The lever part of the mounting arrangement is bent to form a flange 142, which provides increased rigidity to the lever.

The mounting arrangement 130 may, for example, be made from an elastic metal, i.e. a metal having a high elasticity (for example, at least 180 GPa, e.g. at least 190 GPa). For instance, the mounting arrangement may be made from SUS 301, 65Mn, 60Si2Mn or 50CrVA. Other suitable elastic metals (e.g. other steels having a similar Young's modulus) will be apparent to the skilled person.

In other examples, the mounting arrangement may be formed from distinct parts, with one or more parts being made from an elastic metal. For instance, one or more of the driver movement system 140, the clamping portion 131 and/or the declamping mechanism 132 may be made from an elastic metal, such as SUS 101, 65Mn, 60Si2Mn or 50CrVA.

The mounting arrangement 130 further comprises a securing hole 133 and a positioning hole 134 for securing the mounting arrangement to the support 120 of the LED luminaire 100, as described in more detail below. The securing hole and positioning hole are provided on a fixing area 135 of the mounting arrangement, which is connected to each lever 141 by a neck 136. The width of the neck is sufficiently thin, relative to the width of the fixing area and lever, to enable the lever to rotate independently of the rest of the mounting arrangement.

The mounting arrangement 130 shown in FIG. 3 has a central fixing area, with two levers 141 positioned on opposing sides of the fixing area; however, it will be readily apparent to the skilled person that other configurations are possible. For instance, the mounting arrangement may have a single central lever with two fixing areas positioned on opposing sides of the lever.

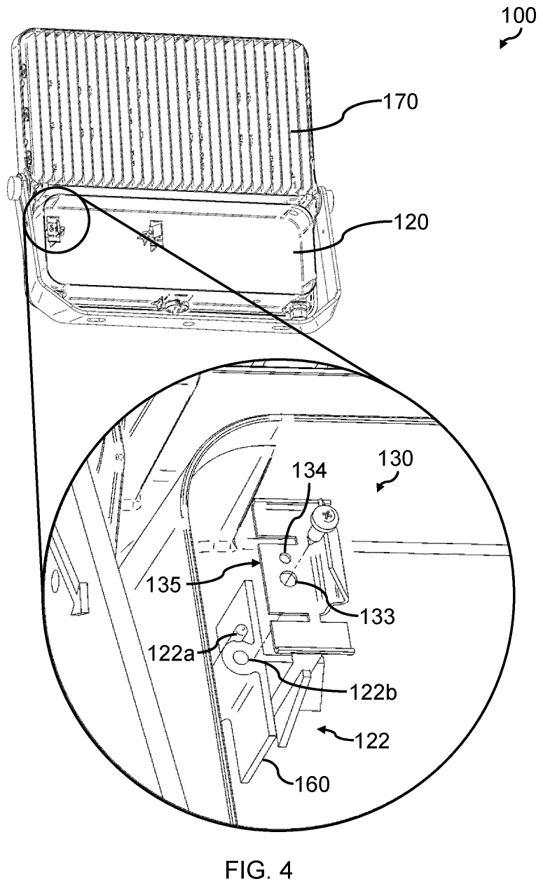

Construction of the LED luminaire 100 may be more clearly understood with reference to FIGS. 4, 5 and 6.

FIG. 4 illustrates a top view of the LED luminaire 100 without the LED driver 110 and covering element 150 fitted to the LED luminaire, in order to more clearly illustrate how the mounting arrangement 130 may be secured to the support 120. FIG. 4 includes an enlarged exploded view of the mounting arrangement and support.

In FIG. 4, a fixing structure 122 extends from the support 120. The fixing structure is configured to engage with (elements of) the fixing area 135 of the mounting arrangement 130. For instance, the fixing structure of FIG. 4 comprises a fourth elongated member 122a and a (threaded) hole 122b. The fourth elongated member is configured to engage with the positioning hole 134 of the mounting arrangement. The threaded hole is configured to align with the securing hole 133, allowing a screw to be inserted therethrough to secure the mounting arrangement to the fixing structure.

In FIG. 4, the fixing structure and the fulcrum 160 are integrally formed, but it will be apparent to the skilled person that these elements may alternatively be provided separately. The fixing structure and/or the fulcrum may additionally be integrally formed with the at least one third elongated member 121 configured to engage with the LED driver 110.

As shown in FIG. 4, the LED luminaire 100 may further comprise a heat sink 170. The heat sink and the covering element 150 may be provided on a same side of the LED luminaire (e.g. both may be provided on an opposite side of the LED luminaire to a light emitting surface).

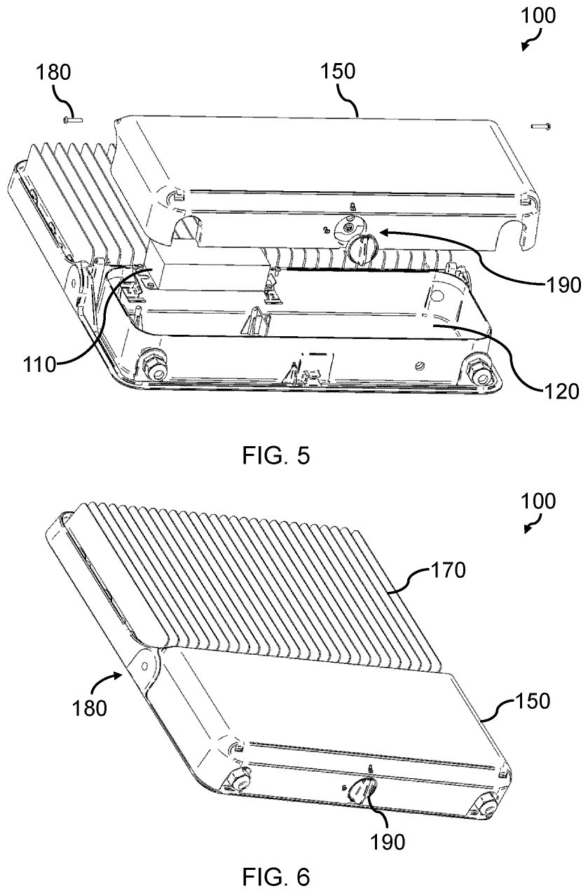

FIG. 5 illustrates an exploded view of the LED luminaire 100, showing how the covering element 150 may be attached to the support 120. As shown in FIG. 5, the covering element may be rotatably attached to the support by a hinge 180. The covering element may thus move between an open position (in which the LED driver 110 is uncovered) and a closed position (in which the LED driver is covered) by rotating about the hinge 180.

A locking arrangement 190 is provided at an opposite side of the covering element 150 to the hinge 180. The locking arrangement is configured to secure the covering element in its closed position in a first locking state, and to permit movement of the covering element about the hinge in a second locking state.

Locking arrangements are very well known, and suitable locking arrangements will be apparent to the skilled person. Preferably, the locking arrangement is configured to be movable between the first and second locking states without the use of tools (e.g. by turning the locking arrangement), to enable the covering element to be more easily opened and secured in its closed position when replacing/repairing the LED driver.

FIG. 6 illustrates a perspective view of the LED luminaire 100, showing the covering element 150 in a closed position, in which the covering element covers the LED driver 110. In FIG. 6, the covering element is secured in its closed position by the locking arrangement 190.

Variations to the disclosed embodiments can be understood and effected by those skilled in the art in practicing the claimed invention, from a study of the drawings, the disclosure and the appended claims. In the claims, the word “comprising” does not exclude other elements or steps, and the indefinite article “a” or “an” does not exclude a plurality.

The mere fact that certain measures are recited in mutually different dependent claims does not indicate that a combination of these measures cannot be used to advantage.

If the term “adapted to” is used in the claims or description, it is noted the term “adapted to” is intended to be equivalent to the term “configured to”. If the term “arrangement” is used in the claims or description, it is noted the term “arrangement” is intended to be equivalent to the term “system”, and vice versa.

Any reference signs in the claims should not be construed as limiting the scope.

1. An LED luminaire comprising:
an LED driver for powering a light emitting arrangement;
a support for the LED driver;
a mounting arrangement for securing the LED driver to the support; and
a covering element configured to movably cover and uncover the LED driver;
wherein the mounting arrangement comprises a driver movement system configured to move the LED driver away from the support and towards the covering element responsive to the covering element moving to cover the LED driver.

2. The LED luminaire of claim 1, wherein:
the covering element is configured to physically contact or engage with the driver movement system when covering the LED driver; and
the driver movement system is configured to move the LED driver away from the support and towards the covering element responsive to the covering element physically contacting or engaging with the driver movement system.

3. The LED luminaire of claim 2, wherein:
the driver movement system comprises a lever configured to move the LED driver away from the support responsive to an application of a pressure at a lever position; and
the covering element comprises a lever engagement element configured to engage with and apply pressure to the lever position as the covering element moves to cover the LED driver.

4. The LED luminaire of claim 3, wherein the lever pivots about a fulcrum extending from the support.

5. The LED luminaire of claim 3, wherein:
the covering element comprises a covering portion configured to cover the LED driver when the covering element is moved to cover the LED driver; and
the lever engagement element comprises at least one first elongated member extending from the covering portion.

6. The LED luminaire of claim 3, wherein the driver movement system further comprises at least one second elongated member extending from the lever position of the lever, wherein the at least one second elongated member is configured to engage with the lever engagement element as the covering element moves to cover the LED driver.

7. The LED luminaire of claim 1, wherein the driver movement system is configured to press the LED driver against the covering element when the covering element covers the LED driver.

8. The LED luminaire of claim 1, wherein the driver movement system is made from an elastic metal.

9. The LED luminaire of claim 8, wherein the elastic metal is SUS301.

10. The LED luminaire of claim 1, wherein the mounting arrangement further comprises:
a clamping portion biased to a first position in which the clamping portion is configured to secure the LED driver to the support; and
a declamping mechanism configured to move the clamping portion to a second position in which the clamping portion permits the LED driver to be moved with respect to the support

11. The LED luminaire of claim 10, wherein the clamping portion and the declamping mechanism are integrally formed.

12. The LED luminaire of claim 10, wherein the driver movement system, the clamping portion and the declamping mechanism are integrally formed.

13. The LED luminaire of claim 1, wherein the covering element is rotatably attached to the support by a hinge.

14. The LED luminaire of claim 1, further comprising a locking arrangement configured to secure the covering element, when covering the LED driver to the support.

15. The LED luminaire of claim 1, wherein the support and covering element together define, when the covering element covers the LED driver, a housing that houses the LED driver therein.
